(19) United States
(12) Patent Application Publication
(10) Pub. No.: US 2009/0069150 A1
(43) Pub. Date: Mar. 12, 2009

(54) DUAL-CYLINDER GASOLINE ENGINE WITH A CENTRIFUGAL CLUTCH

(76) Inventor: Zhixin TAO, Jinan (CN)

Correspondence Address: MATTHIAS SCHOLL, 14781 MEMORIAL DRIVE, SUITE 1319, HOUSTON, TX, 77079, US

(21) Appl. No.: 12/202,507

(22) Filed: Sep. 2, 2008

(30) Foreign Application Priority Data
Sep. 10, 2007 (CN) 200720027272.6

(51) Int. Cl. B60W 10/00

(52) U.S. Cl. 477/77

(57) ABSTRACT

A dual-cylinder gasoline engine comprising a gasoline engine box, a cylinder I, a cylinder II, a centrifugal clutch and a gear box, wherein the cylinder I and the cylinder II are mounted with the gear box; the centrifugal clutch is installed on one side of the gear box the cylinders are located; the gear box is mounted at the rear of the gear box; and the output shaft of the centrifugal clutch is connected with gears in gear box. When in operation, the crankshaft drives the driving wheel of the clutch to rotate. Thus, the belt is driven and it drives the driven wheel of the clutch to rotate, whereby transferring power to vehicle wheels via the gearbox. The clutch is oil-free. The advantages of the invention include reliable use, convenient maintenance, and smooth operation.

### CROSS-REFERENCE TO RELATED APPLICATIONS

This application claims priority benefits to Chinese Patent Application No. 200720027272.6 filed Sep. 10, 2007, the contents of which are incorporated herein by reference.

### BACKGROUND OF THE INVENTION

1. Field of the Invention

The invention relates to a gasoline engine, and particularly to a dual-cylinder gasoline engine with a centrifugal clutch.

2. Description of the Related Art

Most conventional gasoline engines used in motor vehicles and in motorcycles are single-cylinder engines having low drive power. Although some motor vehicles use dual-cylinder engines, these are used in combination with oil-immersed clutches of a frictional plate type, which work in the presence of oil, are difficult to maintain and have low efficiency. Accordingly, much opportunity for improvement remains.

### SUMMARY OF THE INVENTION

In view of the above-described problems, it is one objective of the invention to provide a dual-cylinder gasoline engine applied in small-sized vehicles, featuring reliable use, convenient maintenance, stable operation and environmental friendliness, particularly when installed in dune motorcycles. The advantages of such engines include low centre of gravity, small vibration and strong applicability.

To achieve the above objectives, in accordance with one embodiment of the invention, provided is a dual-cylinder gasoline engine comprising: a gasoline engine box, a pair of cylinders, and a centrifugal clutch, wherein the cylinders are combined with the centrifugal clutch by means of said engine box.

In accordance with this invention, the dual-cylinder gasoline engine further comprises a gear box, wherein said pair of cylinders is cylinder I and cylinder II, and both cylinders are joined together with the gear box. The centrifugal clutch is installed at the cylinders side of the gear box, and the output shaft of the centrifugal clutch is connected with gears in the gear box.

The centrifugal clutch according to the invention comprises a driving wheel, a driven wheel and at least one belt linking the driving wheel and the driven wheel. The driving wheel is mounted with an expansion plate and a compression plate. The expansion plate has a plurality of centrifugal balls inside. Along the outline of the driven wheel there's a frictional wheel which has centrifugal friction modules inside. The driven wheel is connected with gears in the gear box.

The centrifugal clutch according to the invention is mounted at the left or at the right of the pair of cylinders.

The cylinder I and cylinder II according to the invention are installed with said box in forked type arrangement, a horizontally-opposed type arrangement, or in parallel.

According to the invention, when the gasoline engine is operating, the crankshaft of piston in cylinder moves and makes the driving wheel of the clutch rotate. Subsequently, belts are drived and drive the driven wheel of the clutch to rotate, driving gears in the gear box to work, and rotating gears drive vehicle wheels to move. All these happens in an oil-free environment. Furthermore, the dual-cylinder gasoline engine works with centrifugal clutch, bringing about a much better performance.

Advantages of the invention include:

the engine has a low noise, is reliable in use, convenient repair, and has a low cost;

the engine works smoothly, and has a high drive power and drive efficiency;

particularly when applied in dune motorcycles, the engine has a low centre of gravity, small vibration and strong applicability.

### BRIEF DESCRIPTION OF THE DRAWINGS

More detailed description will be given below with reference to accompanying drawings, in which

FIG. 1 is a side view of the dual-cylinder gasoline engine according to one embodiment of the invention;

FIG. 2 is a plan view of the dual-cylinder gasoline engine according to one embodiment of the invention with the clutch being in a partial view;

FIG. 3 is a schematic view of the gear box according to one embodiment of the invention;

FIG. 4 is a schematic diagram of the centrifugal clutch cover of one embodiment of the invention;

FIG. 5 is a schematic diagram of the centrifugal clutch of one embodiment of the invention;

FIG. 6 is a schematic diagram of the platform of the dual-cylinder gasoline engine of another embodiment of the invention;

FIG. 7 is a schematic diagram of the side view of the dual-cylinder gasoline engine of another embodiment of the invention;

FIG. 8 is a schematic diagram of another view of the dual-cylinder gasoline engine of another embodiment of the invention;

FIG. 9 is a schematic diagram of the side view of the dual-cylinder gasoline engine of another embodiment of the invention; and

FIG. 10 is a schematic diagram of the platform of the dual-cylinder gasoline engine of another embodiment of the invention.

Legend: 1. Cylinder I, 2. Cylinder II, 3. Gear box, 4. Centrifugal clutch, 5. Right part of box, 6. Middle part of box, 7. Left part of box, 8. Driving wheel, 9. Driven wheel, 10. Belt, 11. Centrifugal balls, 12. Expansion plate, 13. Compression plate, 14. Friction modules, 15. Frictional wheel, 16. Connecting crankshaft.

### DETAILED DESCRIPTION OF THE EMBODIMENTS

### EXAMPLE 1

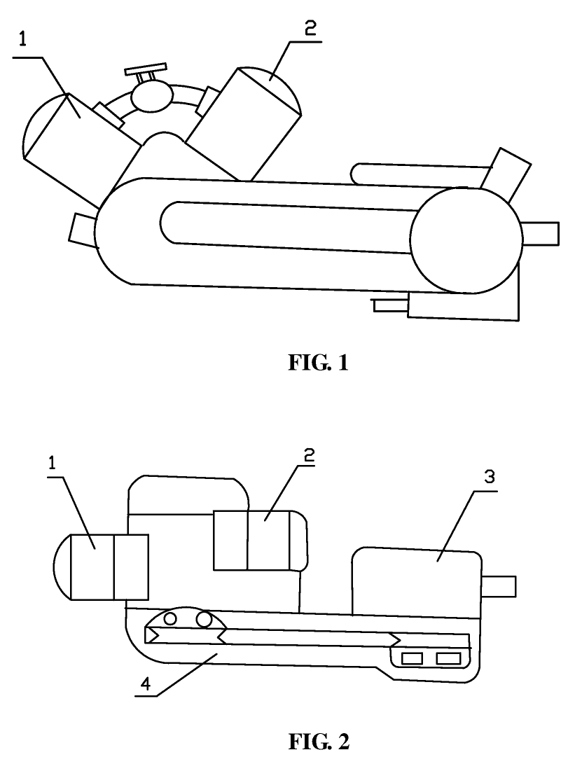

As showed in FIGS. 1 and 2, this invention comprises a gasoline engine box, cylinder I 1, cylinder II 2, a centrifugal clutch 4 and a gear box 3. The cylinder I and cylinder II are installed in the engine box in a fork-type arrangement. The centrifugal clutch 4 is mounted on one side of the engine box the cylinders are located. The gear box 3 is mounted with the rear of the engine box. The output shaft of the centrifugal clutch 4 is connected with gears in the gear box 3.

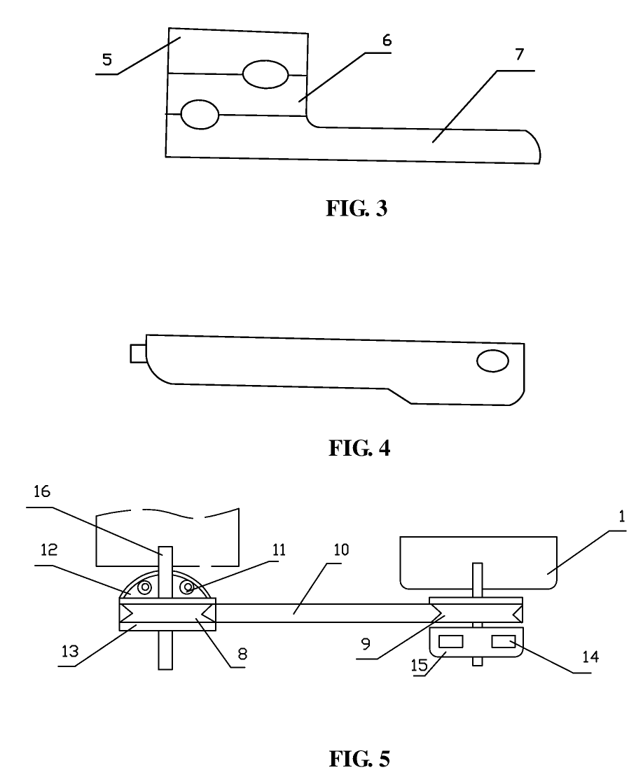

As shown in FIG. 3, the engine box is composed of a right part of box 5, a middle part of box 6, and a left part of box 7. As shown in FIG. 5, the centrifugal clutch is a centrifugal clutch with a belt drive. The centrifugal dry clutch, or CVR for short, which is mounted at the left side of cylinder I and cylinder II, also can be mounted at the right side of both cylinders. The centrifugal clutch comprises a driving wheeling 8, a driven wheel 9 and at least one belt 10 linking them. Both sides of the driving wheel 8 are fixed by an expansion plate 12 and a compression plate 13. The expansion plate 12 has a plurality of centrifugal balls 11 inside. Along the outline of the driven wheel 9, there's a frictional wheel 15 which has centrifugal friction modules 14 inside. The driven wheel 9 is connected with gears in the gear box. FIG. 4 shows the centrifugal clutch cover.

FIG. 5 is a partial view of the centrifugal clutch. The motion theory is as follows. The rotation of engine crankshaft forces the driving wheel of the clutch rotate. Under centrifugal force, the centrifugal balls in the expansion plate of the driving wheel move outwards, and press the compression plate of the driving wheel outwards. Thus, the belt is driven to rotate, driving the driven wheel of the clutch to rotate. The rotation of the driven wheel drives the frictional wheel to rotate. The frictional wheel has centrifugal friction modules inside, which expand under centrifugal force and drive the frictional wheel to rotate, and finally drive the gears of the gear box to turn the vehicle wheels.

### EXAMPLE 2

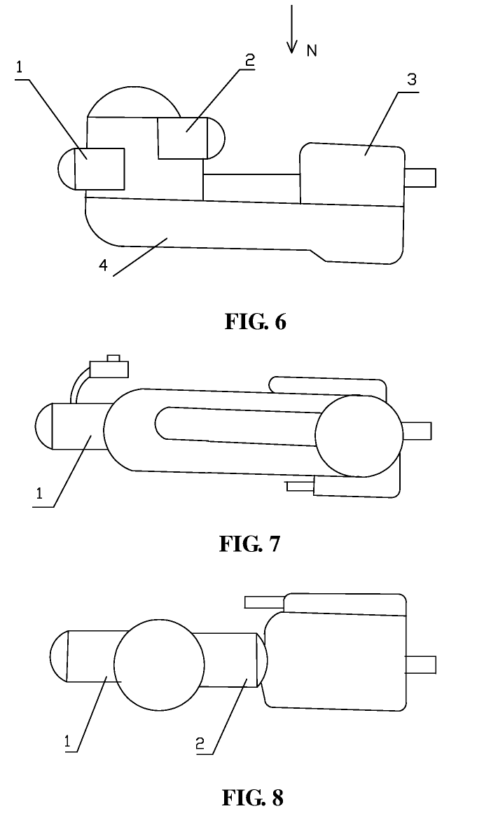

As shown in FIGS. 6, 7, and 8, the cylinder I and cylinder II are mounted with the gear box in a horizontally-opposed way arrangement, other details being the same as in Example 1.

### EXAMPLE 3

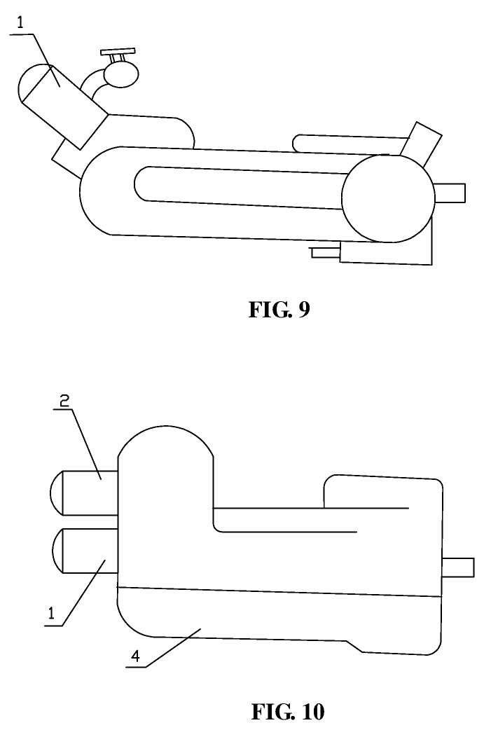

As shown in FIGS. 9 and 10, cylinder I and cylinder II are mounted with the engine box in parallel, other details being the same as in Example 1.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

What claimed is:

1. A dual-cylinder gasoline engine comprising
an engine box;
a pair of cylinders; and
a centrifugal clutch;
wherein
the cylinders are engaged with the centrifugal clutch by means of said engine box.

2. The engine of claim 1, further comprising a gear box wherein said centrifugal clutch, mounted on one side of said engine box said cylinders are located, is connected with gears of the gear box.

3. The engine of claim 2, wherein
said centrifugal clutch comprises a driving wheel, a driven wheel and at least one belt linking said driving wheel and said driven wheel;
said driving wheel is mounted with an expansion plate and a compression plate;
said expansion plate includes a plurality of centrifugal balls;
a frictional wheel including centrifugal friction modules is engaged with the driven wheel; and
said driven wheel is connected with gears in said gear box.

4. The engine of claim 1, wherein said centrifugal clutch is mounted at the left side or the right side of said cylinders.

5. The engine of claim 2, wherein said centrifugal clutch is mounted at the left side or the right side of said cylinders.

6. The engine of claim 2, wherein said cylinders are mounted with the engine box in a fork-type arrangement, in a horizontally-opposed arrangement, or in parallel.
